(19) United States
(12) Patent Application Publication
(10) Pub. No.: US 2007/0286695 A1
(43) Pub. Date: Dec. 13, 2007

(54) Draw bar actuator for vertical milling machines

(76) Inventor: Marc H. Boisvert, Byfield, MA (US)

Correspondence Address: Donald N. Halgren, 35 Central Street, Manchester, MA, 01944, US

(21) Appl. No.: 11/450,525

(22) Filed: Jun. 9, 2006

(51) Int. Cl. B23C 5/26

(52) U.S. Cl. 409/131; 409/233

(57) ABSTRACT

An actuator mechanism arranged on a top head portion of a Bridgeport-type vertical milling machine, for controlling intermittent, tool-changing longitudinal movement of a collet-supporting drawbar in that Bridgeport-type vertical milling machine. The actuator mechanism comprises a pressor pin supported on the head portion of the vertical milling machine. The pin is arranged in reversibly abutable contact with the upper end of the drawbar in the machine. A biasing member is arranged to effect movement of the pressor pin against the upper end of the drawbar to effect movement of the drawbar and permit change of a collet and tool thereby.

### BACKGROUND OF THE INVENTION

1. Field of the Invention

This invention relates to vertical milling machines, and more particularly to draw bar actuator arrangements to permit tools utilized in vertical milling machines to be easily and more efficiently changed as needed.

2. Prior Art

Vertical milling machines have been around for generations. A typical vertical milling machine is the “Bridgeport” type universal standard vertical milling machine. This type of milling machine may be characterized by a vertical spindle, which spindle has been manually activated by a pull handle, to pull a tool towards and push it away from a surface to be worked. Such a pull handle has been complimented in remodeling of certain vertical milling machines by a servo mechanism which have permitted the option of automatic movement, or manual spindle movement by such a pull handle. The manually operable machine is shown in my earlier U.S. Pat. No. 5,846,037, issued on the 8^{th} of Dec. 1998, and incorporated herein by reference, in its entirety.

In a Bridgeport type universal milling machine, a collet is utilized to hold a specific tool. A collet (and tool held therewithin) is removed and a subsequent collet (with a different metal working tool therewith) is locked in place in the spindle, that new tool being pre-installed in that new collet. The outer surface of the collet provides a machined surface so as to accurately mate with the lower end of the spindle, thereby maintaining accuracy of the tool during its milling operation. Such a collet may be known under its more common name as an “R-8” collet. In a standard universal Bridgeport type milling machine, to release a tool therefrom, a draw bar, which extends through the spindle at the top of the machine head, has to be turned, so as to unscrew the lower end of the draw bar from the existing collet within the lower end of the spindle. As the draw bar is unscrewed, the collet is pushed downwardly and the top of the draw bar is given a sudden sharp blow by a heavy object such as a wrench or a hammer. The collet is thus freed from the grip of the lower end of the spindle, and a new collet with a new tool therein is put into the chock of the spindle and the new collet is tightened into place by turning the top of the draw bar which turns the lower end of the draw bar into the female portion of the top of the collet. Such an operation can take between one and two minutes to complete in order to successfully change a tool in a vertical milling machine.

In my aforementioned U.S. Pat. No. 5,846,037, a cup shaped enclosure was arranged over the top of the head, so as to enclose the upper end of the draw bar and to provide an abutting relationship therewith. The lower end of the spindle enclosed the collet. The collet had a gripping head attached thereto at its upper end. The gripping head comprised a generally spherically shaped enlarged engagement portion having a neck which connects the enlarged portion to a base. A coupling member was threadably attached with the lowermost end of the drawbar. The coupling member comprised a generally cylinderically shaped body having a lower end with a plurality of ball bearing support orifices therearound. The coupling member also included an outer sleeve having an innermost surface on its lower end, of stepped diameter. The lowermost end portion of the sleeve has a larger inside diameter and a lip portion of the outer sleeve has a smaller inside diameter. The outer sleeve mated snuggly with and securely wedged into the innermost portion of the collet/tool holding surface at the lower end of the spindle. The inner housing of the coupling member was longitudinally movable relative to the outer sleeve of the coupling member. The controlled relative longitudinal movement between the outer member and the coupling member and the inner housing permits a plurality of balls spaced within the ball socket openings on the inner member to slip radially outwardly thus permitting the generally spherically shaped head on the upper end of the collar to be allowed to slip therepast.

In operation of that vertical milling machine, when the operator desired to change a collet and hence change a tool thereon, the machinist would move the quill feed handle to be in its uppermost position. The rotation of the collet and spindle would be stopped. The machinist pushes the quill feed handle still further about 15 degrees upwardly so as to cause the spindle and draw bar to be pushed upwardly. The uppermost end of the spindle compressed against the compression spring held thereagainst by a nut at the upper end of the drawbar. The drawbar was held stationary against the inside of the cup, and the spindle was moved downwardly to displace the spindle relative to the drawbar. A lower end of the spindle and the outer housing of the coupling wedged therein are also moved relative to the collet and gripping head thereon. The outer housing on the coupling thus exposed the balls within the inner housing portion of the coupling to the larger stepped diameter having a larger open space, permitting those balls to slip radially outwardly from there support position. The balls then move outwardly slightly from the neck portion of the gripping member permitting the gripping head on the upper end of the collet in the grip of the spindle and allow the collet to be readily moved from the lowermost alignment surfaces of the spindle. A second collet with a similar enlarged gripping head may then be inserted in its place and therefore, a new tool thus being properly aligned within the spindle.

Since the quill handle is now removed from those vertical milling machines, and the actuation of the spindle vertically becoming mechanized automatically, a new faster approach is required so as to move the drawbar and the spindle relative to one another so as to permit a collet to be replaced in that spindle, with a new tool and collet.

It is thus an object of the present invention, to overcome the disadvantages of the prior art.

It is yet a further object of the present invention to provide a quick tool change mechanism which will be readily retrofitable into existing Bridgeport type manual universal vertical milling machines.

It is still a further object of the present invention to provide an apparatus for retrofitting existing vertical type milling machines, which have had their quill handles removed, to yet facilitate tool changing thereagain in a fraction of the time than it would otherwise take.

### BRIEF SUMMARY OF THE INVENTION

The present invention relates to a Bridgeport type vertical milling machine having a manually controllable tool feed arrangement thereon. This type of vertical milling machine includes a generally vertically disposed head which rotatably encloses a vertically arranged spindle. The spindle is rotatably driven by motor means connected thereto. The spindle comprises an elongated shaft having a central bore therethrough. The spindle is supported within the head of the machine by a plurality of bearings. An elongated drawbar is arranged through the central bore of the spindle, extending from the uppermost end thereof, to a location adjacent the lowermost end of the spindle. The spindle is movable upwardly and downwardly by a rack and pinion arrangement arranged on the side of the head. The up and down movement of the spindle, is now effected by a servo motor which replaced the quill feed handle formally attached to the rack and pinion mechanism.

The upper end of the drawbar has a threaded portion thereon. A nut is threadedly attached onto the upper end of the drawbar. A compression spring is arranged between the distal uppermost end of the spindle and the nut to provide a compressive force therebetween. The nut is adjustably disposed on the threaded portion of the drawbar so as to adjust the compression in the spring thereadjacent.

A drawbar actuator is arranged on the top of the head, so as to enclose the uppermost end of the drawbar and to provide an abutting relationship therebetween. The lower end of the spindle encloses a collet. The collet is a slender elongated member having a first or lower end onto which a milling tool is secured. The collet has a gripping head attached to its upper end. The gripping head comprises a generally spherically shaped enlarged engagement portion having neck which connects the enlarged portion to a base.

A coupling member is threadedly attached to the lowermost end of the drawbar. A coupling member comprises a generally cylindrically shaped body having a lower end with a plurality of ball bearing support orifices therearound. The coupling member also includes an outer sleeve. The lowermost end of the sleeve mates snuggly with and is securely wedged into the innermost portion of the collet/tool holding surface at the lower end of the spindle. The lower inner housing of the coupling member is longitudinally movable relative to the outer sleeve of the coupling member. The controlled relative longitudinal motion between the outer member and the coupling member and the inner housing permits a plurality of balls spaced within the ball socket openings on the inner member to slip radially outwardly thus permitting the generally spherically shaped head on the upper end of the collet to be allowed to slip therepast.

The drawbar actuator mounted on the top of the head of the milling machine is utilized to actuate the relative longitudinal movement of the drawbar relative to the spindle, so as to permit the collet to be released therefrom. The drawbar actuator in a first preferred embodiment, comprises a generally spherically shaped housing having a threaded lower end which engages a flange on the upper of the head. The housing of the actuator in this embodiment has an upper end with a pivotable handle arranged thereon. An elongated longitudinally movable pressor pin is arranged through a flange and is in alignment with the upper end of the drawbar. The pressor pin has an upper end which is in engagable contact with a portion of the lever arm. A spring is arranged so as to provide a biasing resistance to movement of the handle at the upper end of the actuator housing.

In operation of the Bridgeport vertical milling machine, when it is desired to change a tool at the lower end of the spindle, the rotation of that spindle is stopped, the elongated handle is pivoted downwardly within its housing, so as to provide a downward force on the pressor pin, thus providing a downward force on the upper end of the drawbar. The drawbar, thus being pressed downwardly within the spindle and with respect thereto, pushes the collet from its capture within the collet enclosure. The collet with its associated tool therewith may be thus quickly and easily removed by the machine operator, and a new collet with its new tool therein replaced in the lower end of the drawbar.

The elongated handle on the drawbar actuator is then pivoted upwardly and remains in that position by the biased spring pressing thereagainst and the collet is drawn within the enclosure at the lower end of the spindle and is thus brings a new tool into effective working location within that Bridgeport type milling machine. Resumption of the milling operation by the Bridgeport type milling machine may thus proceed with its new tool there engaged.

A further embodiment of the drawbar actuator comprises an empowered pressor pin actuated by a servo mechanism controlled by the machine operator. Such an actuatable biasing mechanism may be thus also be hydraulic, pneumatic or electronic to responsively move the pressor pin downwardly onto the upper end of the drawbar and hold it there for a short period of time, and then release the pressure on the pressor pin and hence the drawbar, permitting it to return to the proper upper collet-engaging position.

The invention thus comprises an actuator mechanism arranged on a top head portion of a Bridgeport-type vertical milling machine, for controlling intermittent, tool-changing longitudinal movement of a collet-supporting drawbar in that Bridgeport-type vertical milling machine. The actuator mechanism comprises a pressor pin supported on the head portion of the vertical milling machine. The pin is arranged in reversibly abutable contact with the upper end of the drawbar. A biasing member is arranged for effecting movement of the pressor pin against the upper end of the drawbar to effect movement of the drawbar and change of a collet and tool thereby. The biasing member may comprise a pivotable lever swingable on a housing mated on the head portion of the vertical milling machine. The lever in one embodiment, may comprise a manually actuatable lever to press upon the top of the drawbar. The lever may comprises a member which is actuated by an empowered mechanism in another preferred embodiment thereof. The empowered mechanism in several preferred embodiments, may be comprised of an electromechanical or pneumatic/hydraulic actuator which actuator biases the drawbar upwardly and/or downwardly.

The housing in one preferred embodiment, preferably encloses an upper portion of the draw bar. The housing may have a slot in an upper portion thereof, to permit the lever to pivot therethrough. The biasing member may be resisted by a resistance member arranged thereadjacent. The resistance member may comprise a spring to push against the biasing member when the biasing member is moved against the pressor pin or against the top of the draw bar itself in yet a further preferred embodiment thereof.

The invention also includes a method of changing a tool in a Bridgeport-type vertical milling machine, during a metal working procedure. The method comprises one or more of the following steps: arranging an actuator mechanism on the upper end of the milling machine, wherein the actuator mechanism is in biasing contact with a collet-engaging draw bar within the milling machine; actuating the actuator mechanism to effect a downward bias on the draw bar to permit the lower end of the draw bar to release a first tool-holding collet engaged within a spindle at a lower end of the milling machine; replacing the released first tool-holding collet with a second tool-holding collet; and resuming the metal working procedure with the second tool-holding collet within the spindle. The actuator may comprise a lever biasable against a pressor pin in the mechanism, wherein the pin biases against the upper end of the draw bar. The lever may be actuated manually or by a computer or actuator controlled servo mechanism to move the draw bar longitudinally for effecting release and subsequent engagement of a tool-securing collet at its lower end thereof. The lever may be manually actuatable by an operator of said machine, to rapidly change tools therefor.

The invention also comprises an actuator mechanism arranged on a top head portion of a Bridgeport-type vertical milling machine, for controlling intermittent, tool-changing longitudinal movement of a collet-supporting drawbar in the Bridgeport-type vertical milling machine. The actuator mechanism may comprise a vertically displaceable bias member supported on the head portion of the vertical milling machine, the vertically displaceable bias member being arranged in reversible communication/contact with the upper end of the drawbar to effect movement of the drawbar to effect and permit a change of a collet and tool at the lower end of the drawbar thereby. The displaceable bias member may in one embodiment, comprises a pivotable lever intermittently movable against the upper end of the drawbar, which drawbar supports the tool engaging collet at its lower end thereof. The displaceable bias member may also be comprised of a servo mechanism arranged in communication with the upper end of the drawbar.

### BRIEF DESCRIPTION OF THE DRAWINGS

The objects and advantages of the present invention will become more apparent when viewed in conjunction with the following drawings, in which:

FIG. 1 is a side elevational view, in section, of a Bridgeport type vertical milling machine with the drawbar actuator arrangement shown disposed atop its head;

FIG. 2 is a side elevational view, in section, of an embodiment of the drawbar actuator shown in FIG. 1;

FIG. 3 is a view taken along the lines 3-3 of FIG. 2; and

FIG. 4 is a schematic representation of alternative embodiments of the actuator.

### DETAILED DESCRIPTION OF THE PREFERRED EMBODIMENTS

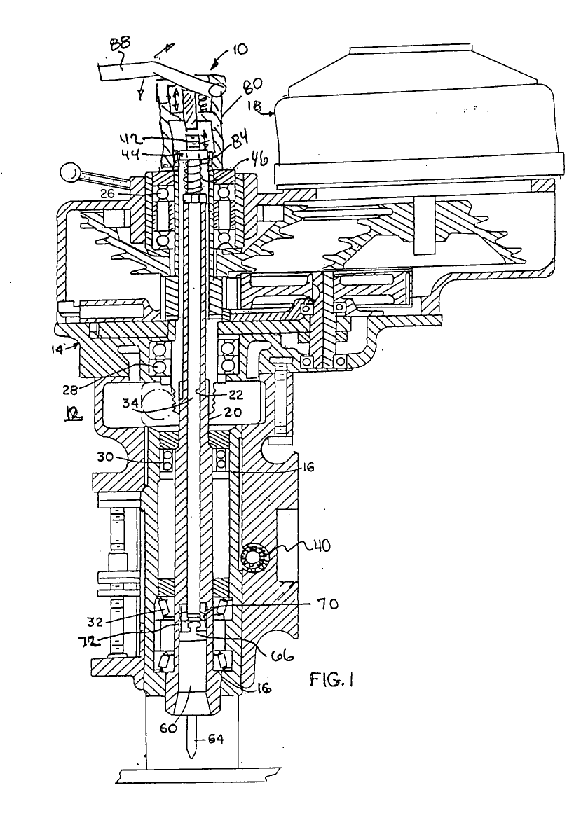

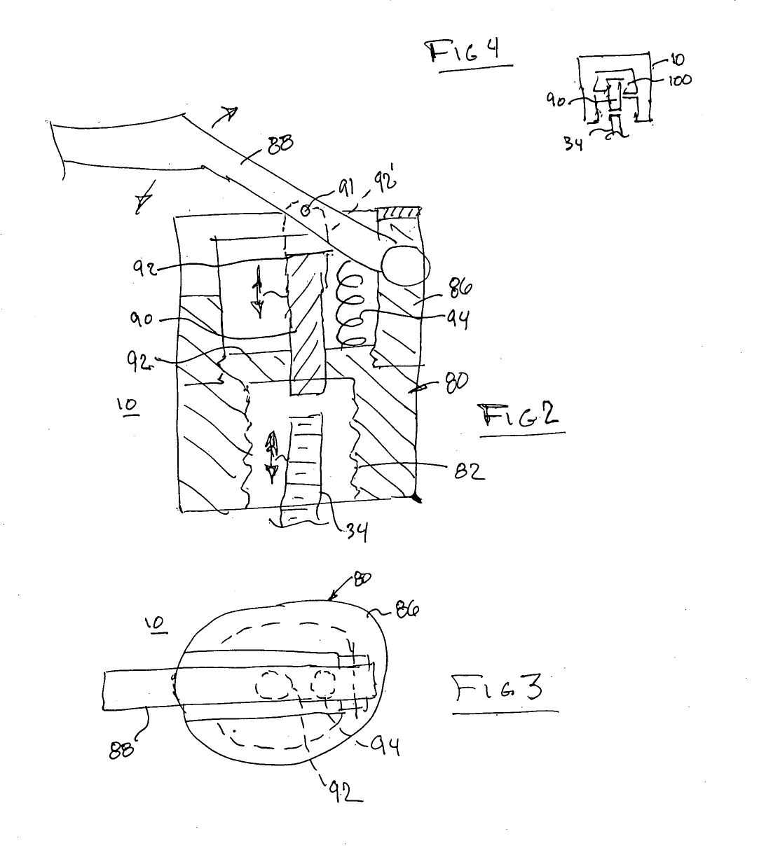

Referring now to the drawings in detail, and particularly to FIG. 1, there is shown the present invention which comprises a draw bar actuator 10 utilized for example, in a “Bridgeport” type vertical milling machine 12. This type of vertical milling machine 12 includes a generally vertically disposed head 14 which rotatably encloses a vertically arranged spindle 16. The spindle 16 is rotatably driven by motor means 18 connected thereto. The spindle 16 comprises an elongated hollow shaft 20 having a, central bore 22 therethrough. The spindle 16 is supported within the head 14 of the machine 12 by a plurality of bearings 26, 28, 30 and 32. An elongated drawbar 34 is arranged through the central bore 22 of the spindle 16, extending from the uppermost end thereof, to a location adjacent the lowermost end of the spindle 16. The spindle 16 is movable upwardly and downwardly by a rack and pinion arrangement 40 arranged on the side of the head 14. The up and down movement of the spindle. 16 may now be also effected by a servo mechanism, not shown, which may be utilized in a complimentary manner with the quill feed handle attached to the rack and pinion mechanism 40, as shown in my earlier incorporated U.S. Pat. No. 5,846,037.

The upper end of the drawbar 34 preferably may have a threaded portion 42 thereon. A nut 44 is preferably threadedly attached onto the upper end of the drawbar 34, as shown in FIG. 1. A compression spring 46 is arranged between the distal uppermost end of the spindle 16 and the nut 44 to provide a compressive force therebetween. The nut 44 is adjustably disposed on the threaded portion 42 of the drawbar 34 so as to adjust the compression in the spring 46 thereadjacent.

The drawbar actuator 10 is arranged on the top of the head 14, so as to enclose the uppermost end of the drawbar 34 and to provide a controlling relationship therewith. The lower end of the spindle 16 encloses a tool-holding collet 60. The collet 60 is a slender, cylindrically-shaped, elongated member having a first or lower end into which a milling tool 64 is secured. The collet 60 has a gripping head 66 attached to its upper end. The gripping head 66 may be comprised of a generally spherically shaped enlarged engagement portion having neck which connects the enlarged portion to a body of the collet 60.

A coupling member 70 is threadedly attached to the lowermost end of the drawbar 34, as described in my aforementioned '037 U.S. patent. The coupling member 70 comprises a generally cylindrically shaped body having a lower end with a plurality of ball bearing support orifices therearound. The coupling member 70 also includes an outer sleeve. The lowermost end of the sleeve mates snuggly with and is securely wedged into the innermost portion of the collet/tool holding surface at the lower end of the spindle 16. The lower inner housing of the coupling member 70 is longitudinally movable relative to the outer sleeve 72 of the coupling member 70. The controlled relative longitudinal motion between the outer member 72 and the coupling member 70 and the inner housing permits a plurality of balls spaced within the ball socket openings on the inner member to slip radially outwardly thus permitting the generally spherically shaped head on the upper end of the collet 60 to be allowed to slip therepast.

The drawbar actuator 10, represented in a first embodiment in FIGS. 1 and 2, is mounted on the top of the head 14 of the milling machine 10 and is utilized to effectuate the longitudinal movement of the drawbar 34 relative to the spindle 16, so as to permit the collet 60 to be released from the lower end thereof. The drawbar actuator 10 in a first preferred embodiment, comprises a generally spherically shaped housing 80 having a threaded lower end portion 82 which engages a flange 84 on the upper of the head 14. The housing 80 of the actuator 10 in this first preferred embodiment has an upper end 86 with a pivotable handle 88 arranged thereon. An elongated longitudinally movable pressor pin 90 is movable arranged through a mid-housing flange 92 and is in longitudinal alignment with the upper end of the drawbar 34, as represented in FIGS. 1 and 2. The pressor pin 90 has an upper end 92 which is in engagable contact with a mid-portion of the lever arm 88, as represented in FIG. 2. A compression spring 94 is arranged between the flange 92 and the handle 88, so as to provide a biasing resistance to movement of the handle 88 within the upper end of the actuator housing 80. The presspr pin 90, in a further embodiment thereof may be comprised of an attached extension member arranged on the upper end of the drawbar 34.

In a further preferred embodiment, the pressor pin 92 may be pivotably supported at its upper end by the lever 88 at a pivot axis 91 thereof, shown by dashed lines 92′ in FIG. 2.

In operation of the Bridgeport vertical milling machine 12, when it is desired to change a tool 64 at the lower end of the spindle 16, the rotation of that spindle 16 is stopped, the elongated handle 88 is pivoted downwardly within its housing 80, so as to provide a downward force on the pressor pin 90, thus also providing a downward force on the upper end of the drawbar 34. The drawbar 34, thus being pressed downwardly within the spindle 16 and with respect thereto, pushes the collet 60 from its capture within the collet enclosure sleeve 72. The collet 60 with its associated tool 64 therewith may be thus quickly and easily removed by the machine operator, and a new replacement collet 60 with its new tool 64 therein thus being replaced in the lower end of the drawbar 34.

The elongated handle 88 on the drawbar actuator is then released and pivoted upwardly and remains in that position by the biased spring 94 pressing thereagainst and the newly emplaced collet 60 is drawn within the enclosure at the lower end of the spindle and thus brings a new tool into effective working location within that Bridgeport type milling machine 12. Resumption of the milling operation by the Bridgeport type milling machine may thus proceed with its new tool there engaged.

A further embodiment of the drawbar actuator 10 may comprise an empowered pressor pin 90 actuated by a electromechanical, pneumatic or hydraulically operated servo mechanism 100 controlled by a computer or by the machine operator. Such an actuatable biasing mechanism 100 may be thus also be hydraulically, pneumatically or electronically empowered to responsively move the pressor pin 90 downwardly onto the upper end of the drawbar 34 (or hold the upper end of just the drawbar 34 itself) and hold it there for a short period of time, and then release the pressure on the pressor pin 90 and hence also release the pressure on the drawbar 34, permitting it to return to the proper upper “collet-supporting” position.

I claim:

1. An actuator mechanism arranged on a top head portion of a Bridgeport-type vertical milling machine, for controlling intermittent, tool-changing longitudinal movement of a collet-supporting drawbar in said Bridgeport-type vertical milling machine, said actuator mechanism comprising:
a pressor pin supported on said head portion of said vertical milling machine, said pin arranged in reversibly abutable contact with the upper end of said drawbar; and
a biasing member for effecting movement of said pressor pin against said upper end of said drawbar to effect movement of said drawbar and change of a collet and tool thereby.

2. The actuator mechanism as recited in claim 1, wherein said biasing member comprises a pivotable lever swingable on a housing mated on said head portion of said vertical milling machine.

3. The actuator mechanism as recited in claim 2, wherein said lever comprises a manually actuatable lever.

4. The actuator mechanism as recited in claim 2, wherein said lever is actuated by an empowered mechanism.

5. The actuator mechanism as recited in claim 2, wherein said housing encloses an upper portion of said draw bar.

6. The actuator mechanism as recited in claim 2, wherein said housing has a slot in an upper portion thereof, to permit said lever to pivot therethrough.

7. The actuator mechanism as recited in claim 1, wherein said biasing member is resisted by a resistance member arranged thereadjacent.

8. The actuator mechanism as recited in claim 7, wherein said resistance member comprises a spring to push against said biasing member when said biasing member is moved against said pressor pin.

9. A method of changing a tool in a Bridgeport-type vertical milling machine, during a metal working procedure, said method comprising:
arranging an actuator mechanism on the upper end of said milling machine, wherein said actuator mechanism is in biasing communication with a collet-engaging draw bar within said milling machine;
actuating said actuator mechanism to effect a downward bias on said draw bar to permit the lower end of said draw bar to release a first tool-holding collet engaged within a spindle at a lower end of said milling machine.
replacing said released first tool-holding collet with a second tool-holding collet; and
resuming said metal working procedure with said second tool-holding collet.

10. The method as recited in claim 9, wherein said actuator comprises a lever biasable against a pressor pin in said mechanism, wherein said pin biases against said upper end of said draw bar.

11. The method as recited in claim 9, wherein said lever is actuated by a servo mechanism to move said draw bar longitudinally for effecting release and engagement of a tool-securing collet at its lower end thereof.

12. The method as recited in claim 9, wherein said lever is manually actuatable by an operator of said machine, to rapidly change tools therefor.

13. An actuator mechanism arranged on a top head portion of a Bridgeport-type vertical milling machine, for controlling intermittent, controlled tool-changing longitudinal movement of a collet-supporting drawbar in said Bridgeport-type vertical milling machine, said actuator mechanism comprising:
a vertically displaceable bias member supported on said head portion of said vertical milling machine, said vertically displaceable bias member arranged in reversible communication with the upper end of said drawbar to effect longitudinal movement of said drawbar to effect and permit a change of a collet and tool at the lower end of said drawbar thereby.

14. The actuator mechanism as recited in claim 13, wherein said displaceable bias member comprises a pivotable lever intermittently movable against the upper end of said drawbar, which drawbar supports said tool engaging collet at its lower end thereof.

15. The actuator mechanism as recited in claim 13, wherein said displaceable bias member comprises a servo mechanism arranged in communication with the upper end of said drawbar.
